(19) United States
(12) Patent Application Publication
(10) Pub. No.: US 2014/0106801 A1
(43) Pub. Date: Apr. 17, 2014

(54) TRANSCEIVER OPERATING IN A WIRELESS COMMUNICATIONS NETWORK, A SYSTEM AND METHOD FOR TRANSMISSION IN THE NETWORK

(71) Applicant: KABUSHIKI KAISHA TOSHIBA, Minato-ku (JP)

(72) Inventors: Nareindiren Tamizhmani, Bristol (GB); Stojan Denic, Bristol (GB); Yue Wang, Bristol (GB); Sadia Quadri, Bristol (GB)

(73) Assignee: KABUSHIKI KAISHA TOSHIBA, Minato-ku (JP)

(21) Appl. No.: 14/054,052

(22) Filed: Oct. 15, 2013

(30) Foreign Application Priority Data
Oct. 15, 2012 (GB) 1218467.7

(51) Int. Cl. H04W 24/02; H04L 1/00

(52) U.S. Cl. CPC H04W 24/02; H04L 1/0015
USPC 455/501

(57) ABSTRACT

The embodiments provide a transceiver, a method and a system for transmission of one or more signals in a wireless communication network. The transceiver according to the described embodiments being capable of collecting channel characteristics based on a received signal from another transceiver in the network; predicting a transmission mode for a subsequent signal transmission on the basis of said collected channel characteristics by determining an interference level of said received signal and estimating an interference level for the subsequent transmission based on the determined interference level and one or more parameters of the received signal, wherein the transmission mode for the subsequent transmission is predicted based on the estimated interference level. The transceiver being further configured to adapt transmission parameters of one or more subsequent transmissions based on the predicted transmission mode.

### FIELD

Embodiments described herein relate generally to a transceiver operating in a wireless communications network, a system and method for transmission of signals between a source and a destination node in the network.

### BACKGROUND

In a wireless communication system, it is desirable that the system is aware of changes of the environment and can adapt its transmission according to such changes. In particular, such change of the environment includes the interference caused by adjacent devices working at the same frequency. The effect that interference has in the performance of wireless communication networks is well recognized. It is a dominant factor which can limit the channel capacity. A known approach to deal with interference is interference cancellation. However, interference cancellation can be difficult to implement for complex networks having a large number of diverse users where each user has to be successfully decoded.

Another known approach is to treat the interference as “noise” and to adjust signal detection criteria according to the noise level. Practical solutions using this approach have been developed for communication systems using cognitive radios. A cognitive radio is a transceiver which automatically detects available channels in a wireless spectrum and accordingly changes its transmission or reception parameters, so more wireless communications may run concurrently in a given spectrum band in a particular space. Some of these solutions use a prediction of noise for future time intervals, which can be used to adjust transmission/reception parameters. However, the interference solutions for cognitive radios only refer to dealing with noise or interference prediction as a cyclostationary process.

Intelligent signal processing is used in a cognitive radio system to use observations to improve some element of performance, so that a certain response is determined for a particular set of inputs. In such systems, a cyclic feedback is received on the performance of a particular system under the effect of a particular radio environment i.e. an assumed noise level. This continuous or cyclic feedback is used by the cognitive radio to adapt and learn from previous measurements so that future performance under such conditions is improved. However, such cognitive radio systems predict parameter changes assuming that the interference is cyclostationary. Such a solution does not provide for situations where the interference is local or random, i.e. where interference is a general stochastic process and changes can occur at any time.

Some practical solutions exist in cellular systems for obtaining the channel state information (CSI) from the neighbouring base stations (BS) to optimise communication at the requesting base station. However, in such solutions, a separate infrastructure is needed for the CSI exchange between a targeted base station (BS) and neighbouring base stations, which is a quite complex.

There is therefore a desire for a simple device, system and/or that is capable of predicting general environment conditions where changes can be quite random, such an interference levels where the interference is a stochastic process.

### BRIEF DESCRIPTION OF THE DRAWINGS

FIG. 1 depicts transceivers 1 to N forming a wireless communication network.

FIGS. 2a and 2b are block diagrams of a transceiver according to one embodiment.

FIG. 2c is a block diagram of a system including the transceivers of FIG. 2a or 2b.

FIG. 3 is a block diagram of a system according to a further embodiment.

FIG. 4 shows a scenario where interference can occur in a cellular system.

FIG. 5 is a flow diagram showing the method of receiving a signal and predicting a transmission mode according to the described embodiments.

FIG. 6 is a flow diagram showing the method of transmitting a signal using an adapted transmission mode.

FIG. 7 is a flow diagram depicting the operation of the system shown in FIG. 3 in the scenario of FIG. 4.

FIG. 8 is a graph showing performance comparison of a communication system with and without transmission adaptation using the presently described embodiments.

### DETAILED DESCRIPTION

Embodiments described in this application provide a transceiver operating in a wireless communications network, a system and method for transmission of signals in the network.

According to one embodiment, there is provided a transceiver operable to establish wireless communications with one or more transceivers, thereby establishing a wireless communications network, the transceiver comprising:

channel characteristics collecting means operable to collect channel characteristics based on a received signal from a signal transmission to said transceiver from another transceiver;

transmission prediction means operable to determine a transmission mode for a subsequent signal transmission from the transceiver to said other transceiver on the basis of said collected channel characteristics, said transmission prediction means including interference determining means operable to determine an interference level of said received signal and to estimate an interference level for the subsequent transmission based on said determined interference level and one or more parameters of the received signal, wherein the transmission mode for the subsequent transmission is determined based on the estimated interference level; and

transmission adapting means for adapting transmission parameters of the subsequent transmission based on the determined transmission mode and transmitting one or more subsequent signals with said adapted transmission parameters.

An aspect of the invention provides a communication system comprising a network having a plurality of transceivers, at least one of said transceivers being as set out above.

Another aspect of the invention provides a method for transmission of one or more signals the method being implemented by a transceiver as set out above and comprising the steps of:

a) collecting channel characteristics based on a received signal from a signal transmission to said transceiver from another transceiver;

b) predicting a transmission mode for a subsequent signal transmission from the transceiver to said other transceiver on the basis of said collected channel characteristics, said step of predicting the transmission mode including determining an interference level of said received signal and estimating an interference level for the subsequent transmission based on the determined interference level and one or more parameters of the received signal, wherein the transmission mode for the subsequent transmission is predicted based on the estimated interference level;

c) adapting transmission parameters of the subsequent transmission based on the predicted transmission mode and transmitting one or more subsequent signals with said adapted transmission parameters.

In a further embodiment, there is provided a communication system comprising a network comprising a first node and a second node, said nodes being transceivers capable of wireless communication in the network,

wherein the first node comprises:

channel characteristics collecting means operable to collect channel characteristics based on a received signal from a signal transmission to said first node from the second node;

transmission prediction means operable to determine a transmission mode for a subsequent signal transmission from the second node to said first node on the basis of said collected channel characteristics, said transmission prediction means including interference determining means operable to determine an interference level of said received signal and to estimate an interference level for the subsequent transmission based on said determined interference level and one or more parameters of the received signal, wherein the transmission mode for the subsequent transmission is determined based on the estimated interference level; and a

a sending means for sending said determined transmission mode to the second node;

wherein the second node comprises:

a sending means for sending signals to the first node;

a receiving means for receiving said determined transmission mode from the first node; and

a transmission adapting means for adapting transmission parameters of the subsequent transmission based on the determined transmission mode; said sending means being configured for transmitting one or more subsequent signals with said adapted transmission parameters.

In a further aspect, an embodiment relates to a method for transmission of one or more signals emitted from a first node to a second node in a wireless communication network, the method being implemented in the system set out above comprising the steps of:

a) collecting channel characteristics of a based on a received signal from a signal transmission to said first node from the second node;

b) predicting a transmission mode at the destination node for a subsequent signal transmission from the second node to the first node on the basis of said collected channel characteristics, said step of predicting the transmission mode including determining an interference level of said received signal and estimating an interference level for the subsequent transmission based on the determined interference level and one or more parameters of the received signal, wherein the transmission mode for the subsequent transmission is predicted based on the estimated interference level;

c) sending said predicted transmission mode to the second node;

d) adapting transmission parameters at the second node for the subsequent transmission based on the received predicted transmission mode; and

e) transmitting one or more subsequent signals with said adapted transmission parameters from the second node.

The embodiments described propose a technique where a received signal is used for an estimation of communication environment conditions, such as interference, and thereafter for prediction of the interference level for the next and/or a subsequent transmission. The present embodiments employ channel state information (CSI) and channel conditions obtained from the received signal for interference prediction for a subsequent signal that is to be transmitted between the source and the destination nodes. By this, the transmission parameters for this subsequent transmission can be adapted to the predicted level of the interference and I one or more parameters of the received signal. This prediction will be a current and a true reflection of interference and other environment condition (such as traffic flow rate, number of interfering devices etc.) at a given time, and may be computed at a transceiver for a subsequent transmission frame(s) or signal(s). This can be used for the interference prediction for a further subsequent transmission i.e. for the transmissions following the next or the designated subsequent transmission frame or signal.

The embodiments described herein provide a transceiver which is capable of adapting transmission parameters to communication environment conditions (i.e. interference) in the wireless communication network and a parameter of the received signal. In the described embodiment, this parameter is the power of a received signal. In other aspects of the present embodiments, one or more other parameters of the received signal such as the modulation format, the data rate, the encoding scheme type etc. may also be used for the adaptation of further transmissions. These other parameters may be used in addition to the signal power of the received signal or may be used instead of the signal power for transmission adaptation according to the described embodiments. A single parameter such as signal power may be used for the transmission adaptation of a subsequent signal, or a combination of a plurality of signal parameters (power, data rate and/or modulation format) of the received signal may be used.

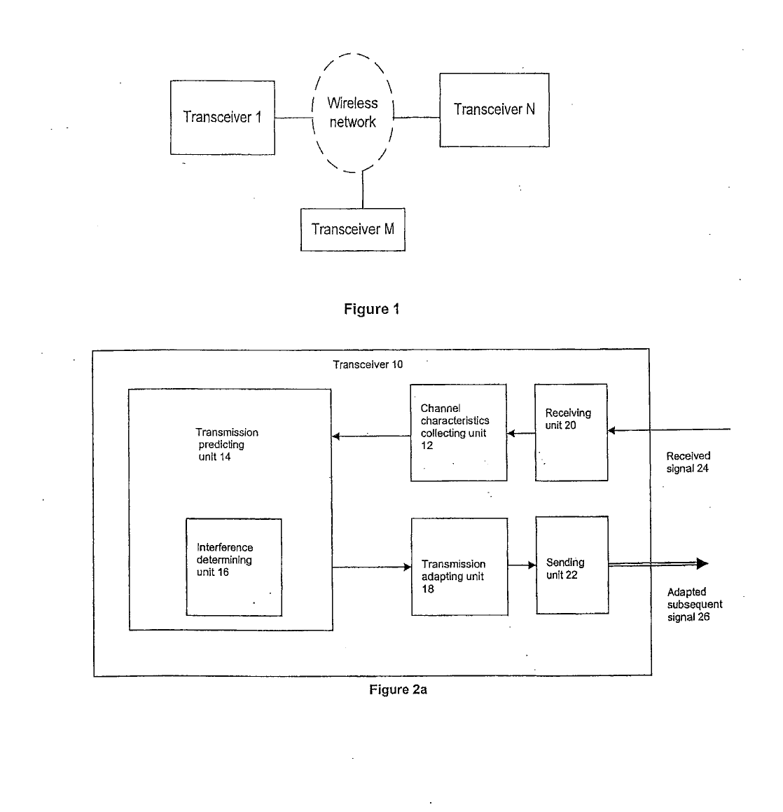

A plurality of such transceivers may be connected to form such a network. This is shown in FIG. 1, where a number of transceivers 1 to N may be connected in a wireless network. A generalized interference, which can be modelled by a general stochastic process is predicted from the received signal(s). In one aspect, the transceiver sends a preamble or a pilot signal as the initial step to an intended destination node to train a random interference model and to acquire the level of interference experienced by the system. The pilot signal or preamble at a known signal power may be sent at the start of the transmission. Assuming that the interference can be modelled as generalised stochastic process and that the signal power and in some case, the noise level of the system is known, the preamble can be used to learn the interference modelled at a particular time. Based on this and the power of the received signal, the embodiments are capable of dynamically predicting a level of interference generated in the environment (or the number of interferers) for subsequent signal transmissions. This is an estimation of the interference power or the strength of the interfering signals in the system that is predicted to affect a subsequent transmission. The embodiments are capable of adjusting transmission parameters for the subsequent transmission based on this estimation by performing radio resource management such as power control/adaptation and frequency allocation for the subsequent signal.

The described embodiments can be incorporated into a specific hardware device, a general purpose device configure by suitable software, or a combination of both. Aspects can be embodied in a software product, either as a complete software implementation, or as an add-on component for modification or enhancement of existing software (such as a plug in). Such a software product could be embodied in a carrier medium, such as a storage medium (e.g. an optical disk or a mass storage memory such as a FLASH memory) or a signal medium (such as a download). Specific hardware devices suitable for the embodiment could include an application specific device such as an ASIC, an FPGA or a DSP, or other dedicated functional hardware means. The reader will understand that none of the foregoing discussion of embodiment limits future implementation of the invention on yet to be discovered or defined means of execution.

In a further aspect, there may be provided a computer program product comprising computer executable instructions which, when executed by a computer, causes the computer to perform a method as set out above. The computer program product may be embodied in a carrier medium, which may be a storage medium or a signal medium. A storage medium may include optical storage means, or magnetic storage means, or electronic storage means.

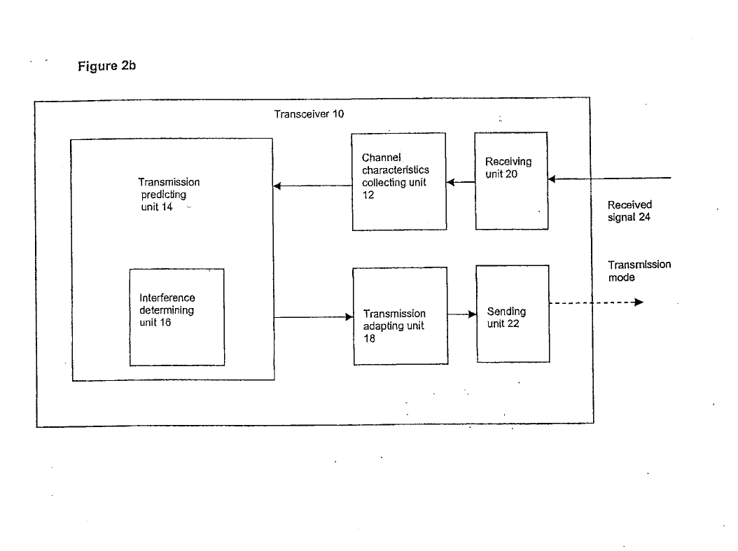

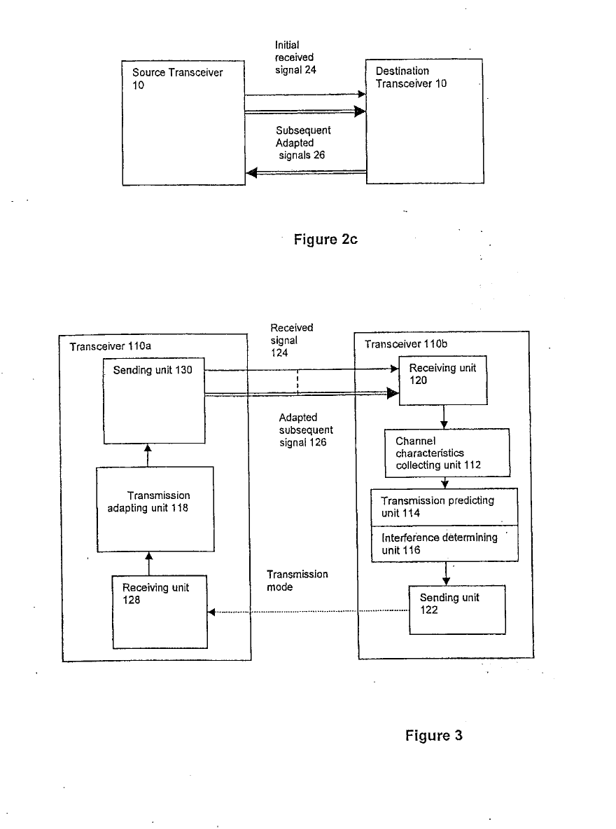

In one aspect, the transceiver of the proposed embodiment is configured to act as the source or the destination node in a wireless communication system. Both the source and the destination node can also be implemented as the transceiver according to the current embodiment. This transceiver is shown in FIGS. 2a and 2b of the accompanying drawings. The following description assumes a scenario where both source and destination nodes are implemented as the transceiver 10 of the described embodiment, as shown in FIG. 2c. However, in some embodiments only the source or the destination node may be implemented as the transceiver 10 of the described embodiment. In other embodiments, such as shown in FIG. 3, one transceiver is designated as source node 110a and another transceiver is designated as a destination node 110b for all communications between them.

The transceiver 10 acting as the source node in the embodiments of FIGS. 2a and 2b for a particular transmission sends an initial signal to the transceiver 10 currently acting as the destination node for the transmission. This signal that is received by the transceiver 10 (the destination node) is processed by a channel collecting unit 12 for collecting channel characteristics that depict the current environment of the communication system including the power level of the initial signal, channel state information (CSI) and other conditions from the received signal. A non-exhaustive list of examples of the collected characteristics could include:
an indication of existing channel traffic/load
number of additional transmitting and/or receiving devices operating at a frequency that is similar to an operation frequency of the source/destination transceiver that are in the vicinity of the transceiver i.e. such as in the same cell or in an adjacent cell
transmission power of the signal
resources allocated to said transmission i.e. radio resource managements such as frequency allocation etc.
duration of transmission
any transmission delays
existing channel noise

In the described embodiments, the power of the received signal is the signal parameter that is used for adaptation of subsequent transmissions. For other embodiments, one or more different parameters such as the modulation format, the data rate, the encoding scheme type etc. may be used for this adaptation, in addition to or instead of the received signal power.

In some aspects, this received signal that is initially received at the destination node contains a preamble or a pilot signal that is transmitted from a source node to a destination node in a network. In other aspects, this signal may be the first signal of a transmission that is to take place between the source and the destination nodes, representing the data that is to be transmitted. The initial signal is transmitted at a known or determined power level at that time. For the initial signal at a time t, where t {0, T_{1 . . .} T_{N}}, the transmitted signal y(t) may be given by:

y(t)=p(t)+i(t)+n(t) Equation 1:

where:

p(t)=signal power representing e.g. a preamble

i(t)=interference power for time t

n(t)=noise experienced in the system (assume that this remains constant for all values of t or it is known statistic)

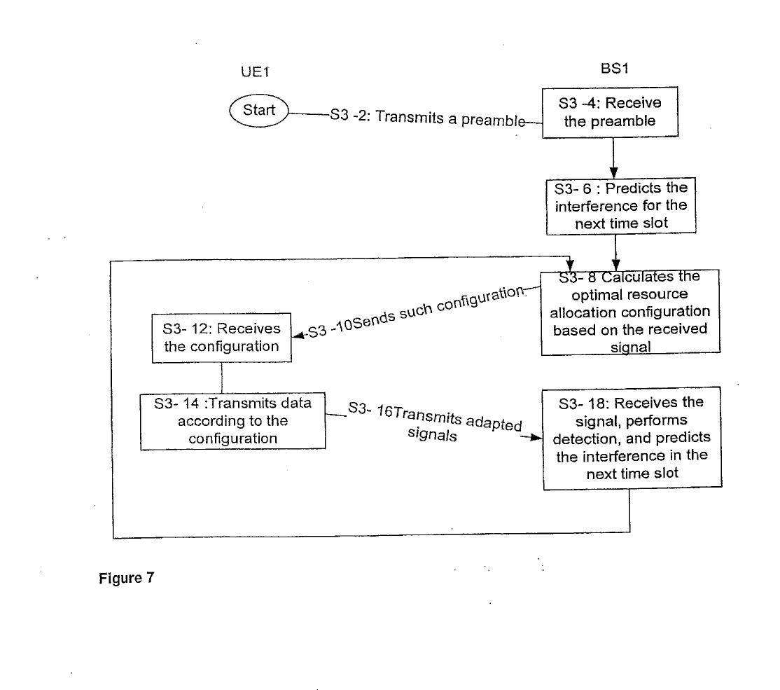

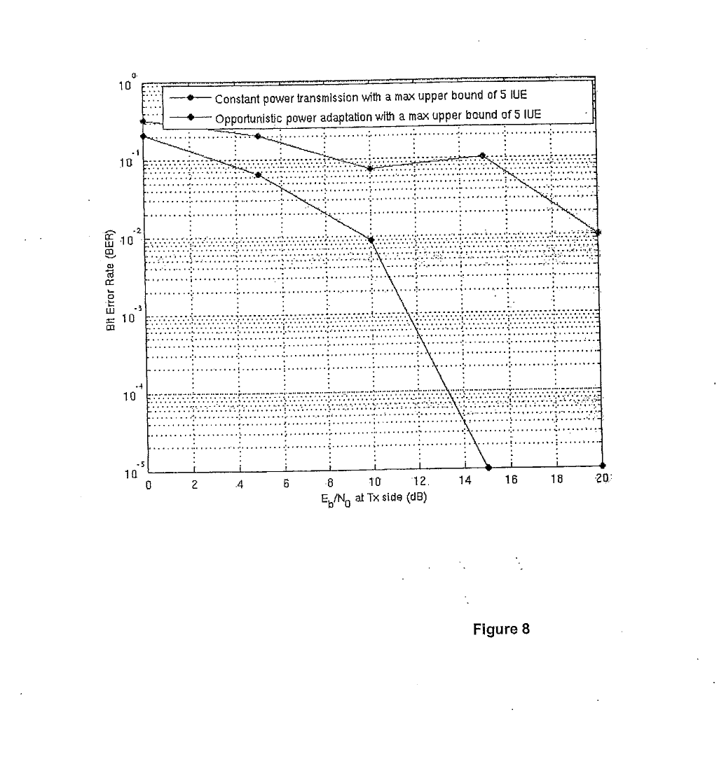

The signal y(t) in equation 1 may contain the initial signal or preamble and represents the received signal 24 in FIGS. 2(a-c) and received signal 124 in FIG. 3. Signal y(t) corresponds to steps S3-2 and S3-4 of FIG. 7.

For the initial signal or preamble at time t=0, p(t) is known and n(t) is of known statistics. The value of interference i(t) is the statistic to be learned at time t=0.

It is assumed that the interference experienced at the system is random or follows a generalised distribution such as Gaussian or a Poisson distribution. Therefore prediction based on the preamble includes training a model of generalised interference and identifying an initial level of interference power experienced by the system. The interference model may be re-trained as transmission progresses or at regular intervals.

The transceiver 10 includes a transmission predicting unit 14 configured to predict a transmission mode or transmission configuration for a subsequent transmission of signal(s) between the source and the destination. This prediction is done using the collected channel characteristics from the received/initial signal 24. The transmission predicting unit 14 includes interference determining unit 16 configured to determine the interference level in the communication environment based on the characteristics received signal. This interference experienced can be determined from the received signal using the collected channel characteristics such as power, average signal strength, noise, overlapping communications etc. Once the current interference is determined, the interference determining unit 16 is configured to estimate an interference level for a subsequent transmission between the source and the destination transceivers 10. This is an estimation of the power of the interference predicted for the subsequent transmission (the predicted interference power level) and is based on the determined interference experienced by the received signal as well as one or more parameters of the received signal. This estimated interference in some cases is also calculated based on the presence of other devices operating at the same frequency and/or near the location of the transceiver 10. The interference learned by the system based on any previously received channel characteristics may also be used in the interference predictions, however; the interference power level estimated for each subsequent transmission is always based on one or more parameters of the received signal, such as signal power, data rate, modulation format, encoding scheme etc.

The subsequent transmission for which the estimated interference is calculated may be the very next transmission frame or signal immediately following the receipt of the received signal 24. This may be the next transmission from the destination transceiver 10 (which now becomes the source) back to the transceiver 10 that was previously the source node.

In other embodiments, the subsequent transmission can be the next signal transmission sent from the original source to the destination node. In this case, the estimated interference will be for the transmissions from the designated source to the designated destination transceiver 10.

In other embodiments, it is not necessary that the subsequent transmission should immediately follow the received signal 24. The subsequent transmission may be for the signal transmissions that occur after a certain interval of time following receipt of the initial signal at the destination, this interval being predetermined. In other aspects the subsequent transmission may take place following a predetermined number of transmissions or transmission frames between the source and the destination nodes. The predetermined time interval or the number of transmissions is preferably set to a small value so that the estimated interference level accurately models the currently experienced communication environment and can be based on the true interference levels of the communication environment.

Once the estimated interference level is determined for the designated subsequent transmission, the transmission prediction unit 14 determines a transmission mode for this subsequent transmission. This transmission mode is a configuration of transmission parameters and/or resources allocated for the subsequent transmission taking into consideration the estimated level of interference or estimated interference power that will be experienced in the communication environment for a subsequent transmission. This is to ensure that the transmission can be efficiently and reliably sent in spite of the generalised interference experienced, and to maintain or improve quality of service of a subsequent transmission, in spite of the interference experienced. A non-exhaustive list of transmission parameters that can be configured according to the transmission mode is given below:
signal transmission power from the intended source to the intended destination. This may be maintained, increased or decreased when compared to the initial or earlier transmission.
radio resource allocation i.e. frequency allocation, bandwidth etc of available channel resources for the subsequent transmission may be amended based on the estimated interference value.
data transmission rate for the subsequent transmission such that it is maintained, increased or decreased.

Similar to equation 1, for a time t=T₁, (the subsequent transmission after t=0), the signal can be represented by

y(T₁)=s(T₁)+i(T₁)+n(t) Equation 2:

where s(T₁) is an indication of the transmission mode based on the estimated interference and the signal parameters of received signal y(t) at t=0; i(T₁) is the interference at t=T₁.

For example, let us assume that the value of s(T₁) constitutes a value of the adapted transmission power for signal y(T₁). This is based on the interference power level i(t) and the power of the received signal y(t) at time t=0.

The signal y(T₁) in equation 2 is considered to be the adapted subsequent signal 26 in FIGS. 2(a-c) and the adapted subsequent signal 126 in FIG. 3. This is based on the signal parameters of y(t), which is the received signal 24/124 for this equation. This signal y(T₁) further corresponds to step S3-14 and S3-16 of FIG. 7.

Once the transmission mode for the subsequent transmission has been determined by the transmission prediction unit 14, a transmission adapting unit 18 of the transceiver 10 is configured to adapt the transmission parameters for the subsequent transmission according to the determined transmission mode s(t). A subsequent signal 26 is then sent by sending means 22 with the adapted transmission parameters from the transceiver 10 to the intended destination node, as shown in FIG. 2a.

In another embodiment, once the transmission mode has been determined by the transmission predicting unit, the sending unit 22 is configured to send this determined transmission mode to another transceiver on the communication system. This other transceiver may be operable to adapt its next transmission based on the received transmission mode. This embodiment is shown in FIG. 2b. Therefore, rather than sending the subsequent signal based on the determined transmission mode, the transceiver 10 of FIG. 2b sends only the transmission mode that has been determined so a designated subsequent transmission takes place in the from another transceiver. This other transceiver may be similar to the transceiver 10 shown in FIG. 2a and discussed above.

This subsequent signal may be considered as the received signal 24 for a further subsequent transmission, i.e. the transmission following the first adapted signal transmission at T₁, so that the next designated subsequent transmission will be adapted based on this signal 26. In the embodiment shown in FIGS. 2a and 2c, this next transmission originates from the transceiver 10, which was the destination for the previous transmission. This now becomes the source for the next transmission and the previous source transceiver becomes the destination.

In the embodiment shown in FIGS. 2b and 3, the transmission following the first adapted transmission T₁, would be the further subsequent transmission, i.e. the next transmission from transceiver 110a (the source), to transceiver 110b (the destination).

This further transmission at say t=T₂ following the first adapted transmission at t=T₁ is given by:

y(T₂)=s(T₂)+i(T₂)+n(t) Equation 3:

where s(T₂) is an indication of the transmission mode based on the estimated interference and signal parameters of signal y(T₁) at t=T₁; i(T₂) is the interference at t=T₂.

In the described embodiment, the value of s(T₂) constitutes a value of the adapted transmission power for signal y(T₂). This is based on the interference level i(T₁) and the power of the received signal y(T₁).

The signal y(T₂) in equation 3 may be considered to be the further subsequent adapted signal represented by signal 26 in FIGS. 2(a-c) and adapted subsequent signal 126 in FIG. 3. This is based on the signal parameters of y(T₁), which is considered to be the received signal 24/124 for this equation. This further corresponds to step S3-18 of FIG. 7.

For the further adapted transmissions at time period T₂ and following time periods T₃ . . . T_{N}, the determination of interference of the previously received signal at time T₁ which will be used to predict the interference for the next time periods may be calculated by any one of the following method:

Taking signal y(T₁) as an example, in one aspect the interference i(T₁) may be determined based on collected channel characteristics of the received signal y(T₁). This determination is similar to the interference determination described above for the signal y(t) which contains a preamble.

In another aspect, the interference i(T₁) may be determined based on the optimal transmission parameters for signal y(T₁), that is in turn based on the previously received signal. In this embodiment, interference determination i(T₁) does not require channel characteristics to be collected again, and may be obtained simply from the available transmission parameters.

Assuming that the optimal transmission parameters for signal y(T₁) constitutes an indication of signal power, since n(t) is a known statistic, in one example the interference power i(T₁) may be determined as follows :

i(T₁)=y(T₁)−s(T₁)−n(t)

Once the interference i(T₁) has been determined, this can be used for estimating interference for future subsequent signals at times T₂ . . . T_{N}.

In the embodiment of the invention shown in FIG. 3 a communication system 100 is provided that that performs interference estimation and transmission power adaptation in a similar way as described above, but with one transceiver designated as source node and another transceiver designation as a destination node for all communications between them. Here, the first transceiver or source node transceiver 110a is provided with a receiving unit 128 and a sending unit 130 and a transmission adapting unit 118 that is similar in function to the transmission adapting unit 18 described in transceiver 10 of the previous embodiment. The second transceiver or destination node transceiver 11b is provided with a receiving unit 120 and sending unit 122, and is also provided with the channel characteristics collecting unit 112, the transmission predicting unit 114 and the interference determining unit 116, all of which are similar in function to the corresponding features of the previously described embodiment (in which a transceiver 10 could be the source or the destination node).

In this further embodiment, once the transmission mode has been determined by the transmission predicting unit 114, this mode is transmitted to the source node transceiver by the sending unit 122 of the destination node. Once received at the receiving unit 128 of the source node, the transmission adapting unit 118 in the source adapts the transmission parameters and transmits the adapted signal 126 using the adapted parameters to the destination node via the sending unit 130 of the source node. In this embodiment, the subsequent transmission always takes place from the designated source node 110a to the designated destination node 110b. This embodiment is suitable for a cellular system where a base station may be the destination node 110b and a user equipment terminal may be the source node 110a.

For the purposes of interference determination for subsequent transmissions, in one aspect the first transceiver or source node 110a is configured to send signals to a the second transceiver 110b based on the optimal transmission mode s(t), the parameters for which it receives from the second transceiver 110b. The second transceiver or destination node 110b would have determined these parameters in the previous time instance T₁ from the received signal y(T₁). For the following instance T₂ where the first transceiver 110a sends a signal and the second transceiver 110b receives the signal y(T₂)=s(T₂)+i(T₂)+n(t), the second transceiver 110b is configured to decode the message s(T₂) based on the interference i(T₂) and predict the interference for the next moment T₃.

One way to predict interference i(T₃) is to collect the channel characteristics by sending a preamble once again between the moments T₂ and T₃.

Alternatively, it is possible for the second transceiver 110b to use the knowledge about the received signal y(T₂) and the parameters of the transmitted signal s(T₂) to determine statistics of the interference i(T₂) e.g. its power. Based on the estimated i(T₂), the second transceiver 110b can predict the interference for the next moment i(T₃). The second transceiver 110b may use this information to determine the optimal configuration for the transmitted signal s(T₃), and is configured to send these parameters to the first transmitter 110a which will commence the transmission at the next time instant T₃.

The above technique may also be implemented by the transceiver 10 and the system shown in FIGS. 2a and 2c.

In another aspect, when the channel changes rapidly, the transmission performance can be improved by periodically sending the preamble signal in predetermined time intervals between message transmissions or by using prediction which will take into account time-varying statistics of the interference, e.g. by applying time-varying Kalman filter or other robust prediction methods.

Besides the examples described above, other means of calculating interference for subsequent signals, without the need for collecting channel characteristics, may also be used for the present embodiments.

The above described process is continued until the required transmissions are completed, i.e. until time T_{N}.

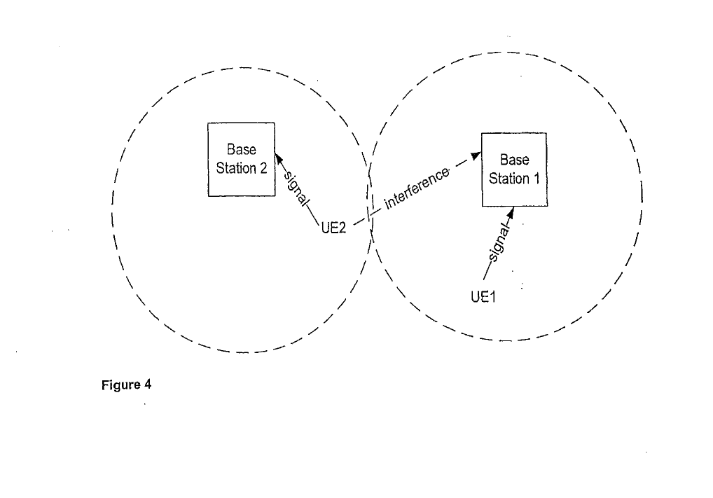

An example scenario which implements the communication system shown in FIG. 3 is illustrated in FIG. 4, where a first base station BS1 is communicating with user equipment (UE) 1 while a second base station BS2 is communicating with UE2. Since UE1 and UE2 may be sharing the same frequency, and in particular UE2 is within the transmission/receive range of BS1, it causes interference to BS1 when actively transmitting. A person skilled in the art will appreciate that this is just an example illustrating an interference scenario. Similar scenarios can be thought of for different systems using femto cells and cognitive radio etc. In practice, there can be multiple UEs at the cell edge that act as the interferer. In the described embodiments, the objective is to predict the interference environment of BS1 and configure its transmission accordingly. Such a configuration can adapt the transmission parameters (e.g. the transmission power) of UE1 according to the predicted interference power level and the signal power of a received signal such that the quality of service (QoS) of the transmission is not degraded. In another embodiment of the invention, BS1 can allocate its resource blocks (in frequency and time) according to the number of interfering UEs in adjacent cells.

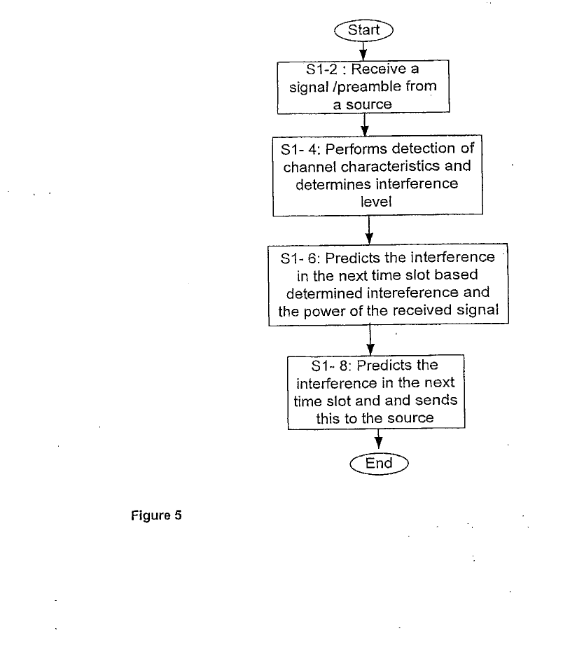

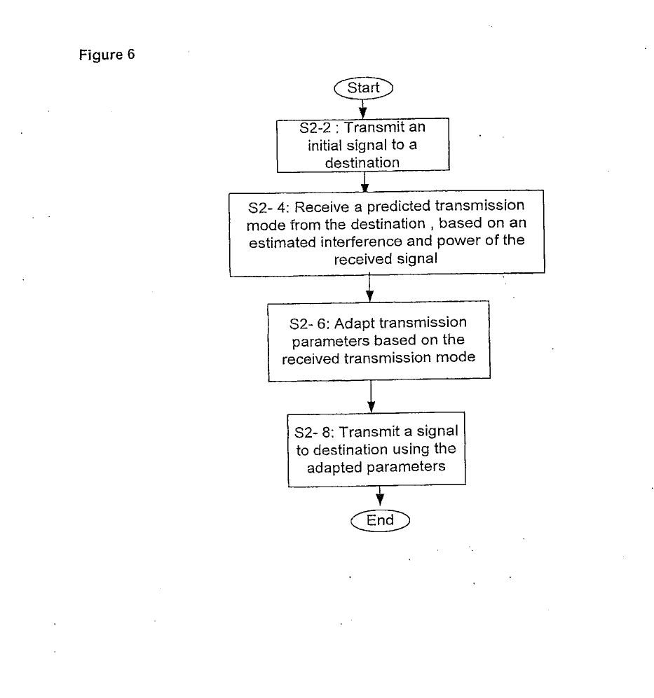

FIGS. 5 to 7 depict examples of the method of transmitting and receiving signals according to the present embodiments. FIG. 5 describes the method of receiving an initial signal and FIG. 6 describes transmitting the adapted subsequent signal. In the proposed invention, a preamble is first transmitted in step S1-2 by a transceiver such as a UE as show in FIG. 4. This preamble may be used for the purpose of interference prediction. Based on the received preamble signal at the BS, the BS can predict the interference power level (or the number of active UEs) for the next time slot in S1-4 and S1-6. This prediction is also based on the power level of the received preamble. According to the predicted interference for the next time slot, the base station calculates the appropriate transmission configuration that should be performed when the UE transmits in the next time slot in step S1-8. Such a configuration can be, for example, resource block allocation from the BS or power adaption required at the UE based on the predicted interference and received signal power. As shown in FIG. 6, once the transceiver (UE) receives the transmission mode in step S2-4, it adapts the transmission parameters in S2-6 and transmits the subsequent signal using the adapted parameters in S2-8.

FIG. 7 is a representation of transmission protocol for the scenario in FIG. 4 showing that the above methods of transmitting/receiving continue until a transmission is complete. Once the UE receives in S3-12 an adapted configuration or a transmission mode from the base station following interference prediction in S3-8, it then transmits the next signal in S3-14. The BS receives this next signal, uses this signal S3-16 to provide an updated prediction of the interference in the third time slot (in addition to extracting UE's data from it), calculates an updated transmission configuration based on the updated prediction and the signal power of the received signal and sends it to the UE in S3-18. The UE again transmits according to the updated configuration in S3-14. Such a process is carried out repeatedly until the transmission finishes. The power of the UE transmission can be adapted such that the signal-to-interference plus noise ratio (SINR) is a constant.

Interference prediction according to the described embodiments can be modelled using a Markov chain model. The Markov chain can be represented by X:={X(k)}_{k≧0}, X(k) ∈ {1, . . . , N}.

According to the Markov property, the next state represented by X depends on only the current state and not past states, where k is the current state, and k can take a value between 1 to N, where N is the number of possible states of the system. In the simplest form, each state could correspond either to the number of interferers or the power level of the interference.

The Markov chain may be completely defined by a N×N transition probability matrix A(k) and the vector of state probabilities P(k)=[Pr{X(k)=1}, . . . , Pr{X(k)=N}]^{T}. The transition probability matrix A(k) contains conditional probabilities aᵢⱼ:=Pr{X(k+1)=i|X(k)=j} to go from a state j to a state i. The evolution of the state probability vector is given by

P(k+1)=A(k)P(k) when P(0) is assumed to be known.

For a practical applications, the transition probability matrix A(k) for a generalised interference system that can have a Gaussian or Poisson distribution can be estimated in several ways, one of these being the sensing of a received interfering signal for certain amount of time which is enough to obtain an accurate A(k) estimate.

The prediction of the interference value can be carried out via its Markov chain representation. In the prediction, two possible cases can be considered: a fully observable case and partially observable case. The fully observable case means that the state of the Markov chain X(k) can be measured accurately, while the latter means that the Markov chain observation X is corrupted by noise. The noisy observation is denoted by Y:={Y(k)}_{k≧1}. The theory of hidden Markov models gives the following recursive filter which can be used for the one-step prediction

Q(k+1)=A(k)Γ(k)Q(k)

where Q(k) is the so-called un-normalized conditional state probability vector, Γ(k) is a diagonal matrix having a vector N[Pr{Y(k+1)|X(k)=1), . . . , Pr{Y(k+1)|X(k)=N}]^{T} on the main diagonal, and P(0)=Q(0). The conditional probability (conditioned on past observations) of being in the state i at the time instant k is determined by

$${P}_{i} ( k ) = \frac{{Q}_{i} ( k )}{{\sum }_{l = 1}^{N} {Q}_{l} ( k )}$$

where Pᵢ(k) and Qᵢ(k) are the ith entries of the vectors P(k) and Q(k), respectively. For the time instant k+1, the prediction of the state \hat{X}\hat{Xₖ₊₁} is obtained by using a maximum likelihood (ML) principle, by choosing the state i having maximum probability of occurrence.

A person skilled in the art will appreciate that although in FIG. 4 only one time slot prediction is used as an example, the prediction for the next multiple time slots are possible by using higher order predictions.

FIG. 5 represents a graph to illustrate the effectiveness of interference prediction according to the described embodiments (the communication system 10 of FIG. 2) where UE transmission power is adapted according to the predicted interference and one or more parameters of the previously received signal. For the purpose of comparison, performance of the communication system 10 is also plotted without power adaption (i.e., uses a constant transmission power throughout the transmission time). Both systems are assumed to have similar total transmission power. This example shows the results of simulations based on the scenario illustrated in FIG. 3. It is assumed that the UE1 employs uncoded qudrature phase shift keying (QPSK) modulation according to the method in FIG. 4 and that the interference is modelled by a Poisson distribution and that the interference power differs from time to time, and it does not follow any periodicity. The method of FIG. 4 when modelled can generate an interference Markov model from a received preamble when the maximum number of the UEs is five. At the destination node, the bit error rate (BER) is measured, and it is compared to the BER of the system which does not change the transmission power according to the estimated interference and the received signal for a subsequent transmission. From the graph it is observed that the system with power adaption by adapting transmission powers according to the described embodiments provides a performance gain compared to that without using power adaption.

Substantial performance gains can be achieved by the embodiments described herein, compared to a system without interference prediction and power adaption based on a received signal for each subsequent transmission. The embodiments apply in general to any random interference model and do not require the periodicity of the interference signal, as is the case in some existing systems. Once interference is predicted, various algorithms can be applied to enhance the reliability of the transmission and to allocate resources more effectively according to the future environment by the adjustment of transmission parameters for each subsequently occurring transmission.

While certain embodiments have been described, these embodiments have been presented by way of example only, and are not intended to limit the scope of the inventions. Indeed, the novel devices, methods, and products described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope of the embodiments.

1. A transceiver operable to establish wireless communications with one or more transceivers, thereby establishing a wireless communications network, the transceiver comprising:
channel characteristics collecting means operable to collect channel characteristics based on a received signal from a signal transmission to said transceiver from another transceiver;
transmission prediction means operable to determine a transmission mode for a subsequent signal transmission between the transceiver and said other transceiver on the basis of said collected channel characteristics, said transmission prediction means including interference determining means operable to determine an interference level of said received signal and to estimate an interference level for the subsequent transmission based on said determined interference level and one or more parameters of the received signal, wherein the transmission mode for the subsequent transmission is determined based on the estimated interference level; and
transmission adapting means for adapting transmission parameters of the subsequent transmission based on the determined transmission mode.

2. The transceiver as claimed in claim 1 wherein the estimated interference level is the power of the interference predicted for the subsequent transmission.

3. The transceiver as claimed in claim 1 wherein said one or more parameters of the received signal include at least one of: signal power, modulation format, data rate, encoding scheme of the received signal.

4. The transceiver as claimed in claim 1 wherein transmission mode is a configuration of transmission parameters and/or resources allocated for maintaining or improving quality of service of a subsequent transmission based on the estimated interference level.

5. The transceiver as claimed in claim 1 wherein said estimated interference level is calculated by the interference determining means based on one of more of the following collected channel characteristics:
existing channel traffic/load
number of additional transmitting and /or receiving devices operating at a frequency that is similar to an operation frequency of said transceiver, in the vicinity of the transceiver
signal transmission power
resources allocated to said transmission
duration of transmission
transmission delay
existing channel noise

6. The transceiver as claimed in claim 1 wherein the transmission mode for a subsequent transmission is configured by adapting one or more of:
signal transmission power from the intended source to the intended destination such that it is maintained, increased or decreased
resource allocation of available channel resources for the subsequent transmission
data transmission rate for the subsequent transmission such that it is maintained, increased or decreased.

7. The transceiver as claimed in claim 6 wherein transmission power adaptation is performed by the transceiver by:
determining the received signal to noise ratio based on the received signal; and
adapting the signal transmission power for the subsequent transmission by keeping said signal to noise ratio constant and not increasing a determined threshold.

8. The transceiver as claimed in claim 1 wherein said subsequent transmission is the transmission that occurs immediately after the received signal.

9. The transceiver as claimed in claim 1 wherein said subsequent transmission is a transmission that occurs after a predetermined interval of time following the received signal.

10. The transceiver as claimed in claim 1 wherein when said subsequent signal transmitted with said adapted transmission parameters is received at said transceiver, this subsequent signal becomes the received signal based on which an interference level for a further subsequent transmission is estimated.

11. The transceiver as claimed in claim 10 wherein the interference level of said subsequent signal is determined based on channel characteristics collected for the subsequent signal.

12. The transceiver as claimed in claim 10 wherein the interference level of said subsequent signal is determined based the transmission parameters of the subsequent signal and the received signal.

13. The transceiver as claimed in claim 11 wherein the estimated interference level for a further transmission following the subsequent signal is based on the determined interference level of the subsequent signal and one or more signal parameters of said subsequent signal.

14. A communication system comprising a network having a plurality of transceivers, at least one of said transceivers being a transceiver as claimed in claim 1.

15. A method for transmission of one or more signals the method being implemented by a transceiver claimed in claim 1 and comprising the steps of:
a) collecting channel characteristics based on a received signal from a signal transmission to said transceiver from another transceiver;
b) predicting a transmission mode for a subsequent signal transmission from the transceiver to said other transceiver on the basis of said collected channel characteristics, said step of predicting the transmission mode including determining an interference level of said received signal and estimating an interference level for the subsequent transmission based on the determined interference level and one or more parameters of the received signal, wherein the transmission mode for the subsequent transmission is predicted based on the estimated interference level;
c) adapting transmission parameters of the subsequent transmission based on the predicted transmission mode.

16. A communication system comprising a network comprising a first node and a second node, said nodes being transceivers capable of wireless communication in the network,
wherein the first node comprises:
channel characteristics collecting means operable to collect channel characteristics based on a received signal from a signal transmission to said first node from the second node;
transmission prediction means operable to determine a transmission mode for a subsequent signal transmission from the second node to said first node on the basis of said collected channel characteristics, said transmission prediction means including interference determining means operable to determine an interference level of said received signal and to estimate an interference level for the subsequent transmission based on said determined interference level and one or more parameters of the received signal, wherein the transmission mode for the subsequent transmission is determined based on the estimated interference level; and a
a sending means for sending said determined transmission mode to the second node;
wherein the second node comprises:
a sending means for sending signals;
a receiving means for receiving said determined transmission mode from the first node;
a transmission adapting means for adapting transmission parameters of the subsequent transmission based on the determined transmission mode; said sending means being configured for transmitting one or more subsequent signals with said adapted transmission parameters.

17. The system as claimed in claim 16 wherein said second node is user equipment (UE) and the first node is a base station.

18. A method for transmission of one or more signals emitted from a first node to a second node in a wireless communication network, the method being implemented in a system as claimed in claim 16 and comprising the steps of:
a) collecting channel characteristics of a based on a received signal from a signal transmission to said first node from the second node;
b) predicting a transmission mode at the destination node for a subsequent signal transmission from the second node to the first node on the basis of said collected channel characteristics, said step of predicting the transmission mode including determining an interference level of said received signal and estimating an interference level for the subsequent transmission based on the determined interference level and one or more parameters of the received signal, wherein the transmission mode for the subsequent transmission is predicted based on the estimated interference level;
c) sending said predicted transmission mode to the second node;
d) adapting transmission parameters at the second node for the subsequent transmission based on the received predicted transmission mode; and
e) transmitting one or more subsequent signals with said adapted transmission parameters from the second node.

19. The transceiver as claimed in claim 2 wherein said one or more parameters of the received signal include at least one of: signal power, modulation format, data rate, encoding scheme of the received signal.

20. The transceiver as claimed in claim 12 wherein the estimated interference level for a further transmission following the subsequent signal is based on the determined interference level of the subsequent signal and one or more signal parameters of said subsequent signal.
